(19) United States
(12) Patent Application Publication
(10) Pub. No.: US 2019/0323481 A1
(43) Pub. Date: Oct. 24, 2019

(54) WIND ROTATING APPARATUS AND WIND POWER GENERATOR

(71) Applicant: NGUYEN CHI CO., LTD., District 12, Ho Chi Minh City (VN)

(72) Inventor: Nguyen Thanh LE, Ho Chi Minh City (VN)

(73) Assignee: NGUYEN CHI CO., LTD., District 12, Ho Chi Minh City (VN)

(21) Appl. No.: 16/461,921

(22) PCT Filed: Nov. 15, 2017
(86) PCT No.: PCT/JP2017/041110

§ 371 Date: Jun. 13, 2019

(30) Foreign Application Priority Data
Nov. 17, 2016 (JP) 2016-223907

(51) Int. Cl. F03D 3/04; F03D 3/06

(52) U.S. Cl. CPC F03D 3/0481; F03D 9/25; F03D 3/06

(57) ABSTRACT

A wind rotating apparatus capable of efficiently generating electric power even in the case of slight wind or the like, and a wind power generator equipped with wind rotating apparatus. Wind rotating apparatus includes: wind collection unit for introducing wind through inlet port, collecting and discharging wind through outlet port; sirocco fan which rotates about an axis by virtue of air discharged from outlet port of wind collection unit; rotary shaft provided coaxially with sirocco fan; planetary gear mechanism for transmitting rotation of sirocco fan to rotary shaft while increasing its rotation speed. Since a permanent magnet is provided on rotary shaft and coil is provided on lower casing, even if rotation speed of sirocco fan is low in the case of slight wind or the like, rotation speed of rotatary shaft can still be increased.

### TECHNICAL FIELD

The present invention relates to a wind rotating apparatus and a wind power generator.

### BACKGROUND ART

In recent years, with an increased awareness on environment, a wind power generator has attracted public attention as a regenerative energy power generator. In particular, small type wind power generator can be installed basically anywhere in which there is wind.

For this reason, particularly in buildings such as buildings where there is a high need for electricity, as power supply to auxiliary facilities such as lighting of shared parts of a building and as complementary power supply facilities for use in a power failure, wind power generators are installed around the building or on the roof thereof, expecting that they can be fully utilized.

Patent document 1 has disclosed an example of a wind rotating apparatus for effectively utilizing wind to aim at an efficient operation of a wind power generator.

The wind rotating apparatus includes a wind collecting type turbine which is integrally formed by including a front wind fuselage, an intermediate wind fuselage in which a wind turbine is installed, and a rear wind fuselage.

The front wind fuselage has a wind inlet, and is configured such that the cross-section of the front wind fuselage is gradually reduced from the wind inlet to a connection with the intermediate wind fuselage, while the intermediate wind fuselage is configured such that the reduced cross-section of the front fuselage is enlarged or remains unchanged until a junction with the rear fuselage. The rear wind fuselage is characterized in that it has a wind outlet, and its cross-section is enlarged from the connection with the intermediate wind fuselage to the wind outlet.

### CITATION LIST

### Patent Document

Patent Document 1: JP-A-2016-1001

### SUMMARY OF THE INVENTION

### Technical Problems

However, in the above-discussed conventional wind collecting and rotating apparatus, electric power is generated utilizing the rotation of the wind turbine. But, in the case of a slight wind or the like, rotation speed of the wind turbine is low and thus it is difficult to effectively generate electricity.

The present invention has been accomplished in view of the above circumstances, and it is an object of the invention to provide a wind rotating apparatus and a wind power generator provided with the wind rotating apparatus, which is capable of efficiently generating electric power even in the case of a slight wind or the like.

### Solution to the Problems

In order to achieve the above object of the present invention, the wind rotating apparatus comprises:

a wind collection unit for introducing wind through an inlet port, collecting the wind and discharging the wind through an outlet port;

a rotary member which rotates about an axis by virtue of an air discharged from the outlet port of the wind collection unit;

a rotary shaft provided coaxially with the rotary member and rotatable about the axis; and

a rotation transmission mechanism for transmitting the rotation of the rotary member to the rotary shaft while increasing its rotation speed

In the present invention, since the rotation transmission mechanism is provided for transmitting the rotation of the rotary member to the rotary shaft with increasing the rotation speed of the rotary member, the rotation speed of the rotary member, which rotates around the axis by virtue of the air discharged from the outlet port of the wind collection unit, can be transmitted to the rotary shaft by the rotation transmission mechanism.

Therefore, even if the rotation speed of the rotary member is low in the case of a slight wind or the like, the rotation speed of the rotary shaft can still be increased. As a result, it is possible to efficiently generate electric power by connecting the power generator to the rotary shaft.

Further, according to the above configuration of the present invention, the rotation transmission mechanism is constituted by a planetary gear mechanism; a ring gear of the planetary gear mechanism is attached to the rotary member; a sun gear of the planetary gear mechanism is attached to the rotary shaft; a planetary gear of the planetary gear mechanism engages the ring gear and the sun gear.

Using such a configuration, it is possible to easily adjust the speed-up amount of the rotary shaft by adjusting the number of teeth and the diameter of the ring gear, the planetary gear and the sun gear.

Further, according to the above configuration of the present invention, the rotary member is constituted by a sirocco fan, and the ring gear is attached to the sirocco fan.

Using such a configuration, since the sirocco fan is rotated by the air discharged from the outlet port of the wind collection unit and the ring gear is rotated accordingly, it is possible to exactly transmit the rotation of the sirocco fan to the rotary shaft through the planetary gear and the sun gear.

Moreover, according to the above configuration of the present invention, the wind collection unit has a flow passage cross section which becomes smaller from the inlet-port towards the outlet port; a wind guider member for directing the air discharged from the outlet port to some of the blades is provided between the outlet port and some of the blades provided along the circumferential direction on the outer circumference of the sirocco fan.

According to such a configuration, since the flow cross-section of the wind collection unit decreases from inlet port toward the outlet port, it is possible to discharge the wind from the outlet port with an increased speed. Therefore, it is possible to increase the rotation speed of the sirocco fan, thus improving the power generation efficiency.

In addition, since the wind guide member is provided between the outlet port of the wind collection unit and some of the blades of the sirocco fan, it is possible for the wind (air) discharged from the outlet port to hit the blades by virtue of the wind guide member. Therefore, the sirocco fan can be rotated smoothly.

The wind power generator according to the present invention is provided with the above-described wind rotating apparatus, wherein: the rotary shaft projects in the axial direction from the rotary member; a first fixed member is provided on the outside of the protruding rotary shaft; a permanent magnet is provided on one of the rotary shaft and the first fixed member, and a coil is provided on the other of the rotary shaft and the first fixed member, with a predetermined gap formed between the permanent magnet and the coil.

In the present invention, since the rotation of the rotary member can be transmitted to the rotary shaft with an increased speed by virtue of the rotation transmission mechanism of the wind rotating apparatus, it is possible to increase the rotation speed of the rotary shaft, even if the rotation speed of the rotary member is low in the case of a slight wind or the like. Further, since a permanent magnet is provided on one of the rotary shaft and a first fixed member, and a coil is provided on the other of the rotary shaft and the first fixed member with a gap formed between the coil and the permanent magnet, it is possible to efficiently generate electric power through the cooperation between the permanent magnet and the coil.

Further, according to the above configuration of the present invention, a second fixed member is provided inside the rotary member of the wind rotating apparatus, a permanent magnet is provided on one of the rotary member and the second fixed member, and a coil is provided on the other of the rotary member and the second fixed member, with a predetermined gap formed between the permanent magnet and the coil.

According to the above-described configuration, in addition to the power generation based on the rotation of the rotary shaft, it is possible to generate electric power through the cooperation between the permanent magnet and the coil by virtue of the rotation of the rotary member. Namely, it becomes possible to perform power generation through two systems.

### Effects of the Invention

According to the present invention, since the rotation transmission mechanism is provided for transmitting the rotation of the rotary member to the rotary shaft while increasing the rotation speed of the rotary member, even if the rotation speed of the rotary member is low in the case of a slight wind or the like, the rotation speed of the rotary shaft can still be increased. As a result, it is possible to efficiently generate electric power by connecting the power generator to the rotary shaft.

### BRIEF DESCRIPTION OF THE DRAWINGS

FIG. 1A is a perspective view showing a wind power generator according to an embodiment of the present invention, when viewed obliquely from the front side.

FIG. 1B is a perspective view seen from the diagonal front side, showing a state where the wind collection unit is directed in the opposite direction.

FIG. 2A is a perspective view of the wind power generator when viewed from an oblique back side.

FIG. 2B is a perspective view as seen from an oblique back side showing a state where the wind collection unit is directed in the opposite direction.

FIG. 3 is a plan view of the wind power generator.

FIG. 4 is a cross-sectional view of the wind power generator.

FIG. 5 is an enlarged view showing an essential part of the wind power generator of FIG. 4.

FIG. 6 is a front view showing the lower part of the wind power generator.

FIG. 7 is a schematic plan view showing the sirocco fan being turned by the wind collected by the wind collection unit.

### DESCRIPTION OF EMBODIMENTS

Hereinafter, embodiments of the present invention will be described with reference to the drawings.

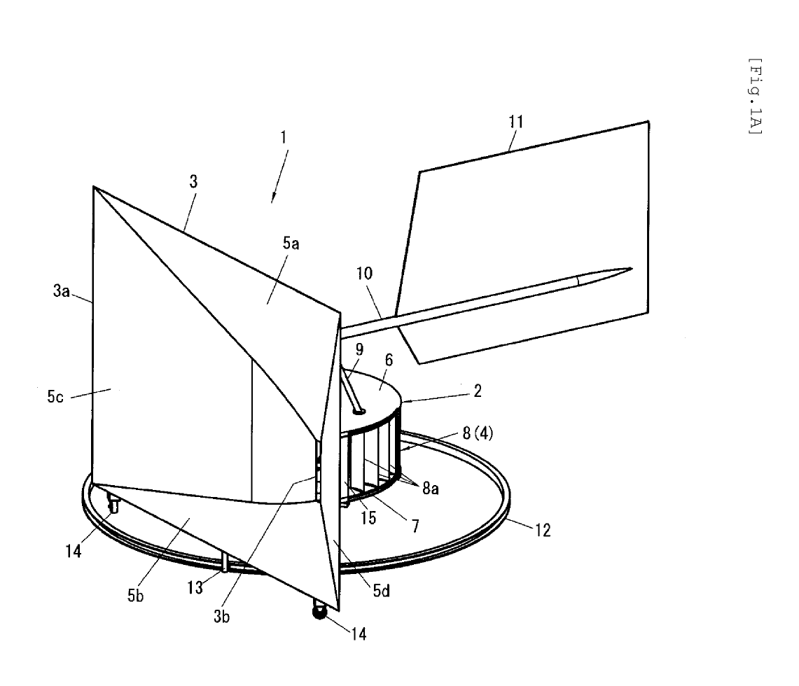

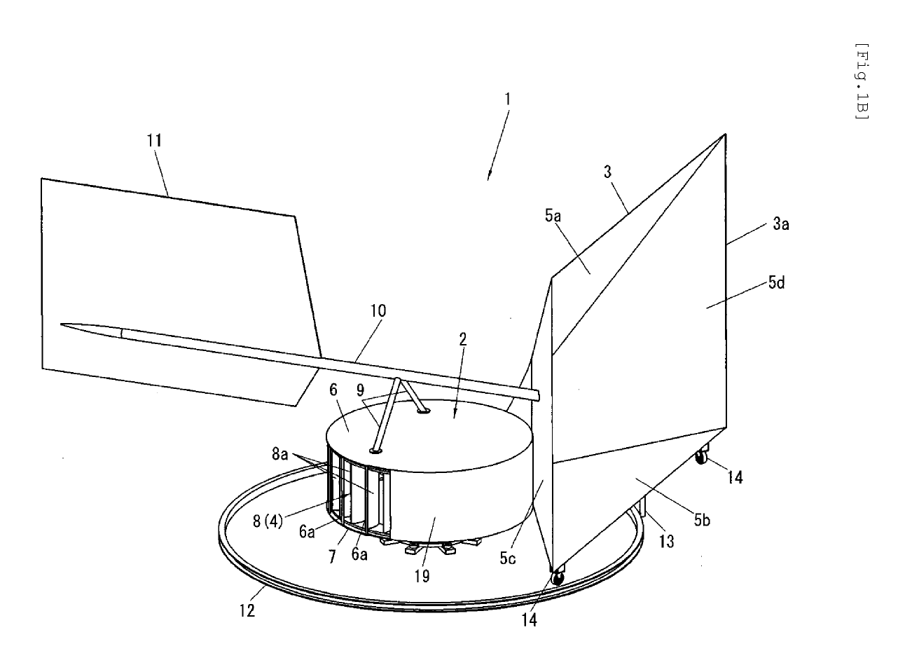

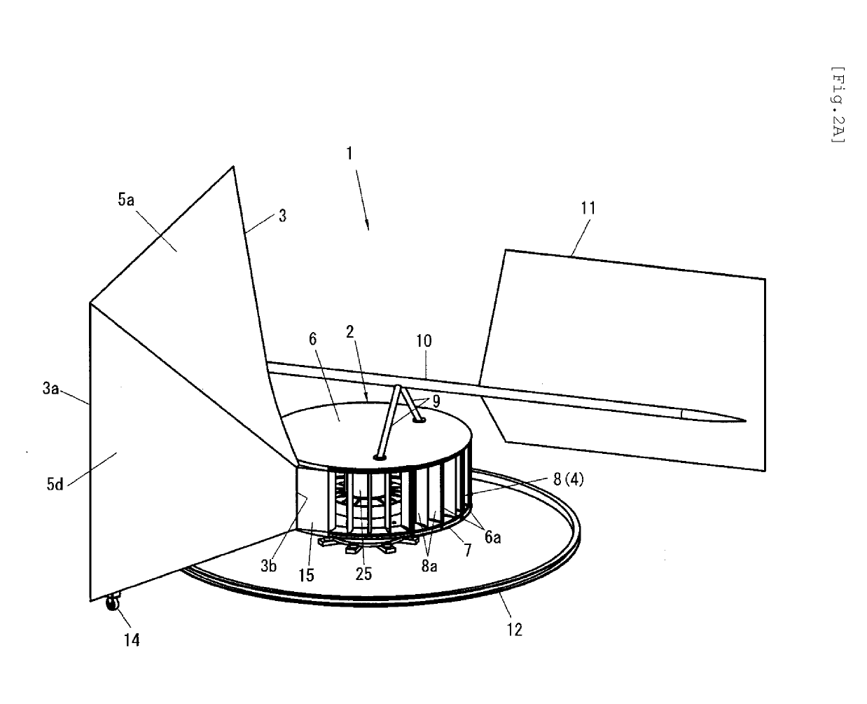

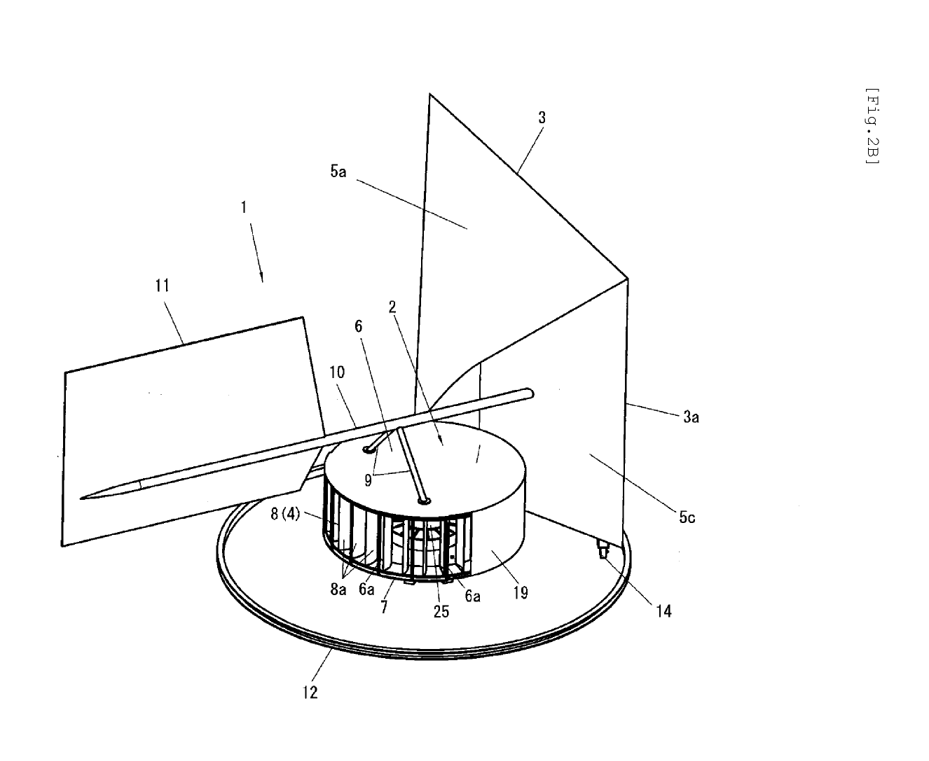

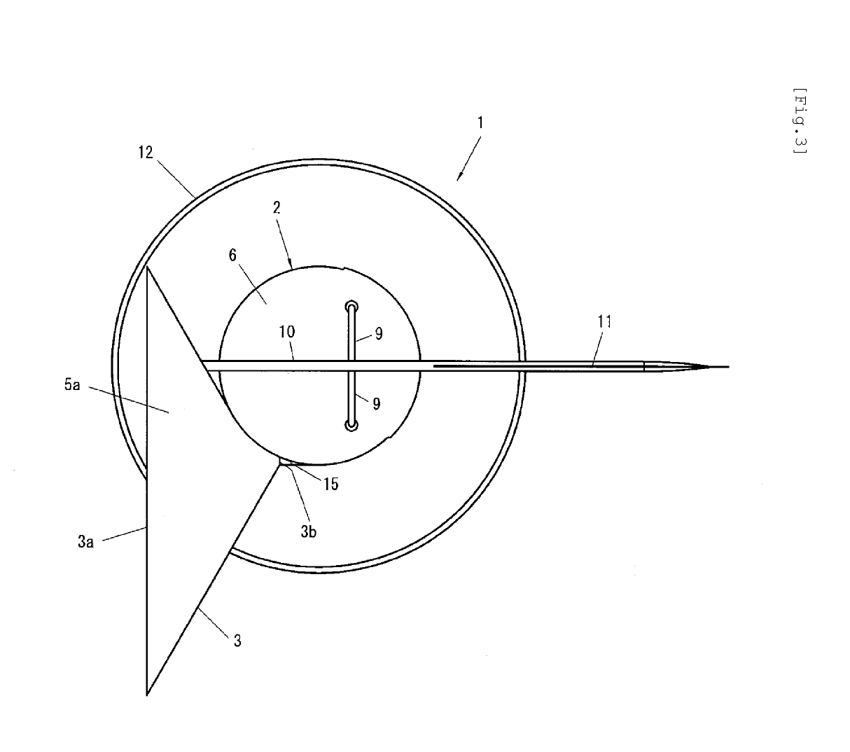

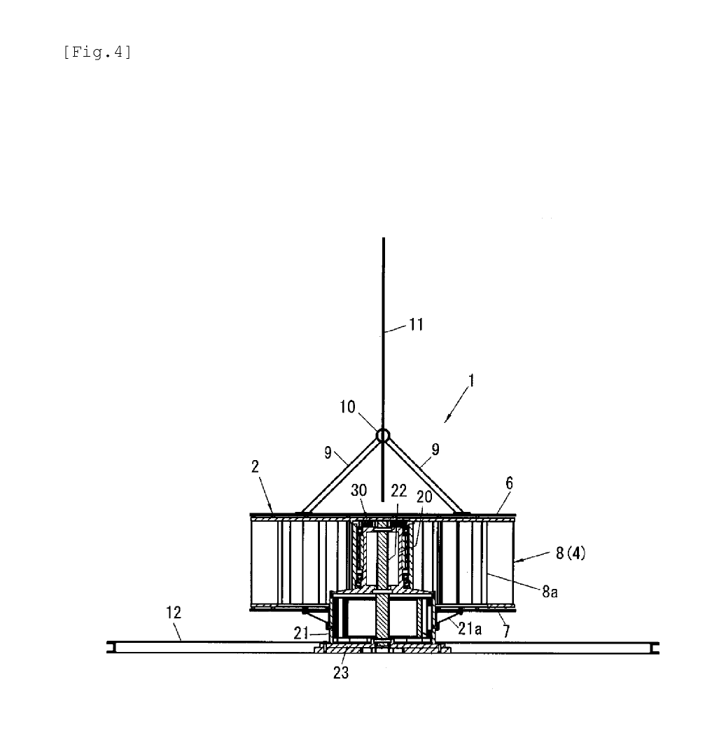

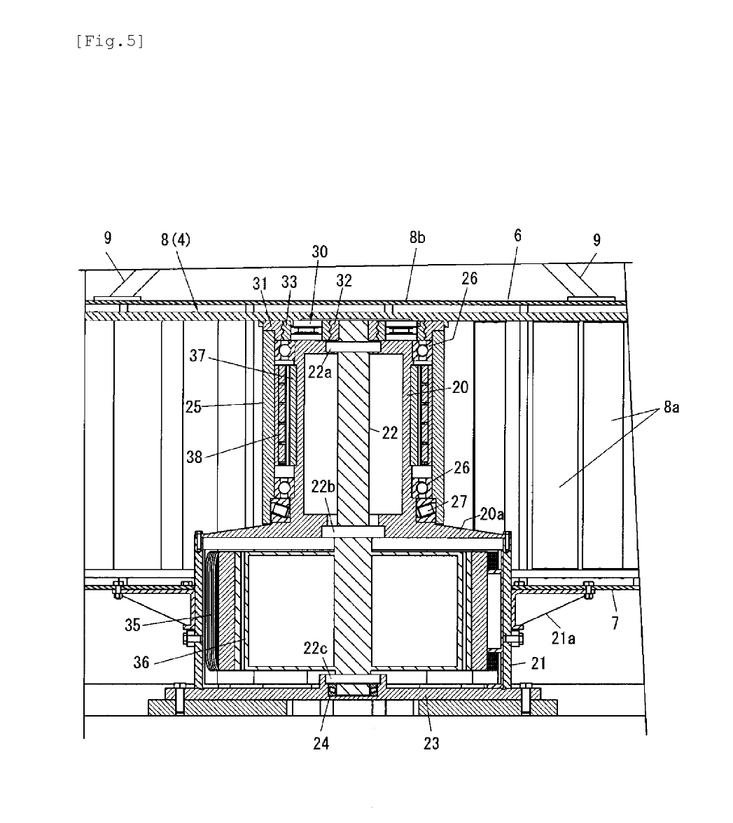

FIG. 1A shows a wind power generator 1 formed according to the present embodiment, which is a perspective view seen from an oblique front side, and FIG. 1B is a perspective view seen from the oblique front side showing that an air inlet port is facing in the opposite direction. FIG. 2A is a perspective view seen from an oblique back side, FIG. 2B is a perspective view seen from the oblique back side, showing the air inlet port facing in the opposite direction. FIG. 3 is a plan view, FIG. 4 is a cross sectional view, FIG. 5 is an enlarged view of the main portion of FIG. 4, all showing the wind power generator configured according to the present invention.

As shown in FIGS. 1-3, the wind power generator 1 includes a wind rotating apparatus 2.

The wind rotating apparatus 2 includes an wind collection unit 3 and a rotary member 4.

The wind collection unit 3 is provided with an inlet port 3a which introduces wind (air), and an outlet port 3b which discharges the introduced wind (air). The inlet port 3a is formed into a rectangular shape, and the wind collection unit 3 also includes four plate members 5a, 5b, 5c, 5d extending respectively from the upper/lower lateral edges and the left/right longitudinal edges of the inlet port 3a toward the outlet port 3b.

The plate members 5a-5d are arranged to be closer to each other toward the outlet port 3b, so that the wind collection unit 3 has a flow passage becoming smaller from the inlet port 3a toward the outlet port 3b.

The outlet port 3b is formed into a vertically long rectangular slit, and the lengths of the left/right longitudinal edges and the upper/lower lateral edges of the outlet port 3b are sufficiently shorter than the lengths of the longitudinal edges and lateral edges of the inlet port 3a.

Therefore, in the wind collection unit 3, a large amount of normal pressure air is introduced through the inlet port 3a, and the flow of the air is then bent (squeezed) by virtue of the four plate members 5a, 5b, 5c, 5d and is discharged as high density high pressure wind through the outlet port 3b.

The rotary member 4 is constituted by a sirocco fan 8, arranged between disk-shaped upper plate 6 and lower plate 7 which are vertically spaced from each other. Also, between the upper and lower plates 6, 7, a plurality of rod-like holding members 6a for keeping an interval between the upper and lower plates 6, 7 are provided at a predetermined interval in the circumferential direction, thereby connecting the upper and lower plates 6, 7 by virtue of the holding members 6a.

The upper plate 6 and the lower plate 7 are provided to be rotatable about their axis, and they are synchronously rotatable since they are mutually connected by the holding members 6a. On the other hand, the sirocco fan 8 can also be rotated around the axis independently of the upper plate 6 and the lower plate 7. Here, the upper plate 6 and the lower plate 7 are provided coaxially with the sirocco fan 8.

Two pillars 9, 9 are obliquely fixed to the upper plate 6, and a middle portion of a horizontal bar 10 is fixed to the tips of the two pillars 9, 9. Here, the horizontal bar 10 is disposed substantially horizontally, and the back surface of the wind collection unit 3 is fixed to the front end thereof.

In addition, a tail wing member 11 is substantially vertically fixed to the base end portion of the horizontal bar 10. Here, the tail wing member 11 is formed into a substantially rectangular plate, and the side surface thereof is disposed at right angles to the front surface of the inlet port 3a of the wind collection unit 3.

Therefore, when the wind blows from a certain direction, the upper plate 6 rotates so that the wind collection unit 3 rotates around the axis of the upper plate 6, causing the inlet port 3a of the wind collection unit 3 to face the wind blowing direction, in a manner such that the wind strikes the side surface of the tail member 11 and this side surface and the blowing direction become mutually parallel. Thus, regardless of the wind blowing direction, the wind can always be taken in from the inlet port 3a of the wind collection unit 3.

Further, a circular ring-shaped guide rail 12 is provided coaxially with the rotation axis of the upper plate 6 on the radially outer and lower side of the sirocco fan 8, and the guide rail 12 is formed to have U-shaped cross section. Further, the guide rail 12 is fixed to the installation surface on which the wind power generator 1 is installed.

On the other hand, a slider 13 is provided to project downwardly from the plate member 5b to the lower surface of the wind collection unit 3, and the lower end of the slider 13 is circumferentially slidably engaged with the guide rail 12. Further, two freewheels 14, 14 are attached to the plate member 5b, with one freewheel 14 being able to travel inside the guide rail 12, and the other free wheel 14 being able to travel outside the guide rail 12.

Therefore, when the wind collection unit 3 rotates, the slider 13 slides along the guide rail 12 in the circumferential direction, while the free wheels 14, 14 travel on the installation surface, so that the wind collection unit 3 can rotate smoothly.

Between the outlet port 3b of the wind collection unit 3 and some of the blades 8a provided in plural in the circumferential direction on the outer periphery of the sirocco fan 8, a wind guide member 15 is provided for guiding the air discharged from the outlet port 3b toward some of the blades 8a.

The air guide member 15 is a plate-like member extending along a part of the outer periphery of the sirocco fan 8, and the base end thereof is attached to the edge of the outlet port 3b of the wind collection unit 3. Here, the wind guide member 15 extends from the outlet port 3b along the circumferential direction of the sirocco fan 8 by a predetermined length, and is provided to cover several blades 8a of the sirocco fan 8 from the outside.

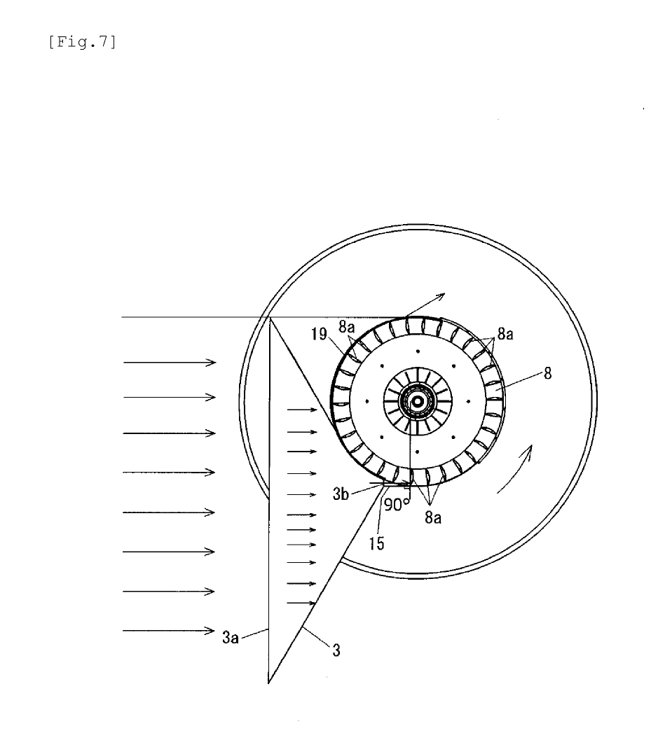

Therefore, the high pressure air (wind) discharged from the outlet port 3b hits several blades 8a of the sirocco fan 8 one after another, thereby causing the sirocco fan 8 to rotate. On the other hand, since the several blades 8a hit by the high pressure air are covered by the wind guide member 15 from the outside, the air discharged from the outlet port 3b is guided by the wind guide member 15 and efficiently hits the several blades 8a. Meanwhile, as shown in FIG. 7, the air discharged from the outlet port 3b of the wind collection unit 3 hits efficiently the blades 8a (arranged at about 90 degrees with respect to the tangent of the sirocco fan 8 in the vicinity of the outlet port 3b) which are disposed at about 90 degrees with respect to the discharge direction of the air discharged from the outlet port 3b of the wind collection unit 3. As a result, the sirocco fan 8 rotates smoothly.

In addition, a cover member 19 is provided on a part of the outer peripheral side of the sirocco fan 8. The cover member 19 is formed into an arc band plate along the outer periphery of the sirocco fan 8, and its width in vertical direction is substantially equal to an interval between the upper plate 6 and the lower plate 7. Further, the upper edge of the cover member 19 is fixed to the outer peripheral edge of the upper plate 6, and the lower edge of the cover member 19 is fixed to the outer peripheral edge of the lower plate 7.

Further, as shown in FIG. 7, the cover member 19 extends from the outlet port 3b of the wind collection unit 3 in a direction opposite to the rotation direction of the sirocco fan 8 by approximately half of the outer peripheral length of the sirocco fan 8. Therefore, approximately half of the outer peripheral area of sirocco fan 8 is covered by cover member 19. Further, the outer peripheral surface of the sirocco fan 8 covered by the cover member 19 is caused to face the direction of the wind blowing toward the wind collection unit 3.

Therefore, most of the wind flowing toward the wind collection unit 3 can be taken in through the inlet port 3a of the wind collection unit 3, but a part of the wind having flowed outside the inlet port 3a hits the opposing outer peripheral surface (facing the wind blowing direction) of the sirocco fan 8. Accordingly, when there is no cover member 19 as described above, the wind will hit the blades 8a located on the opposing outer peripheral surface of the sirocco fan 8, and a force acts to rotate the sirocco fan 8 in clockwise direction, as shown in FIG. 7.

On the other hand, the wind discharged from the outlet port 3b of the wind collection unit 3 tries to rotate the sirocco fan 8 in the counterclockwise direction, as shown in FIG. 7. Therefore, although this rotation direction (counterclockwise direction) and the above-described clockwise direction (caused by the wind) are mutually opposite, in the present embodiment, since cover member 19 is provided, the wind will not hit the blades 8a positioned on the opposing outer peripheral surface of sirocco fan 8. For this reason, the sirocco fan 8 can be smoothly rotated by the wind discharged from the outlet port 3b of the wind collection unit 3.

Further, as shown in FIGS. 4 and 5, a substantially cylindrical upper casing 20 is provided inside the sirocco fan 8. A flange portion 20a is formed at the lower end portion of the upper casing 20, and this flange portion 20a is provided below the upper casing 20, and fixed at an upper end portion of a cylindrical lower casing 21 provided coaxially with the upper casing 20.

Further, the upper end portion of the lower casing 21 is located inside the lower end portion of the sirocco fan 8, and a portion below the upper end portion of the lower casing 21 protrudes downwardly from the sirocco fan 8. On the other hand, the lower plate 7 is provided with a circular hole, and the upper end portion of the lower casing 21 is disposed to protrude inside the lower end portion of the sirocco fan 8 through the hole.

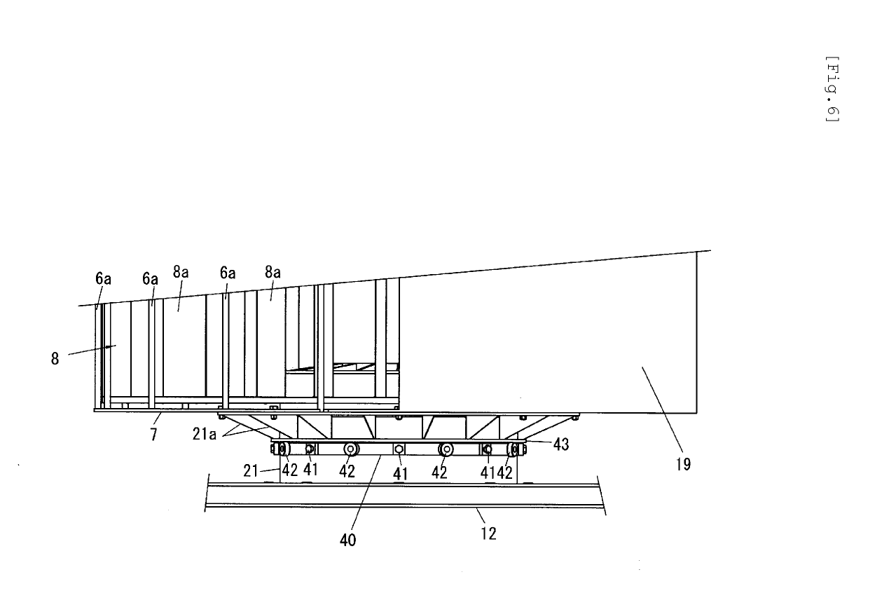

Further, as shown in FIG. 6, a ring-shaped fixed member 40 is fixed to the outer peripheral surface of the lower end portion of the lower casing 21 by virtue of bolts 41. Here, a plurality of bolts 41 are provided at a predetermined interval in the circumferential direction of the fixed member 40.

Moreover, the fixed member 40 is provided with a plurality of rollers 42 at a predetermined interval in the circumferential direction of the fixed member 40. Each of the rollers 42 is supported by a shaft fixed to the fixed member 40 so as to be freely rotatable in forward and reverse directions.

Further, a plurality of brackets 21a are fixed to the lower plate 7 at predetermined intervals in the circumferential direction on the outer peripheral side of the lower casing 21 projecting downwardly from the sirocco fan 8, while the lower plate 7 is supported from below by the brackets 21a. In addition, a ring-shaped flange part 43 is fixed to the lower end portions of the brackets 21a, and this flange part 43 is rotatable integrally with the lower plate 7, the bracket 21a, and the upper plate 6.

Then, when the rollers 42 abut against the lower surface of the flange portion 43, the flange portion 43 is supported by the rollers 42 and can be rotated in the forward and reverse directions. That is, the rollers 42 support the lower plate 7, the upper plate 6, the cover member 19, the wind collection unit 3, the tail wing member 11 and the like, in a manner such that they can be integrally rotatable.

Further, as shown in FIG. 4, a rotary shaft 22 is provided inside the upper casing 20, such that the rotary shaft 22 is coaxial with the axis of the sirocco fan 8 and rotatable about the axis of the sirocco fan 8. That is, as shown in FIG. 5, flange portions 22a and 22b are respectively provided at the upper end and the center of the rotary shaft 22, and the flange portion 22a is rotatably supported by the upper plate of the upper casing 20, while the flange portion 22b is rotatably supported by the lower flange portion 20a of the upper casing 20.

The rotary shaft 22 penetrates the flange portion 20a and protrudes axially downwardly from the sirocco fan 8, while the flange portion 22c is provided at the lower end portion of the rotary shaft 22. The flange 22c is rotatably supported at the central portion of a disk-shaped substrate 23 provided at the lower end portion of the lower casing 21. That is, a hole is formed in the central portion of the substrate 23, and the flange 22c is rotatably provided in the hole. Further, an angular bearing 24 is provided between the lower end portion of the rotary shaft 22 and the flange 22c on one hand and the hole provided at the central portion of the substrate 23 on the other.

A cylindrical rotary body 25 is provided inside the sirocco fan 8 and outside the upper casing 20, such that the rotary body 25 is coaxial with the sirocco fan 8 and can rotate in synchronization with the sirocco fan 8. That is, a pair of upper and lower bearings 26, 26 are provided between the outer peripheral surface of the upper casing 20 and the inner peripheral surface of the rotary body 25. Further, an angular bearing 27 is provided among the lower end of the upper casing 20, the flange portion 20a and the lower end of the rotary body 25. In this way, the rotary body 25 is rotatably supported by the upper casing 20.

A rotation transmission mechanism 30 is provided on the upper side of the upper casing 20 for transmitting the rotation of the sirocco fan 8 to the rotary shaft 22 while increasing the rotation speed of the sirocco fan 8.

That is, the rotation transmission mechanism 30 is configured by using the planetary gear mechanism 30. The planetary gear mechanism 30 is provided between the upper casing 20 and the upper plate 8b of the sirocco fan 8, including a ring gear 31, a sun gear 32 provided at the rotation center of the ring gear 31, and a plurality of planetary gears 33. The rotation center of the ring gear 31 coincides with the rotation center of the rotary shaft 22.

The upper surface of the ring gear 31 is fixed to the lower surface of the upper plate 8b of the sirocco fan 8, and the rotary body 25 is fixed to the lower surface and the outer peripheral surface of the ring gear 31. Therefore, as the sirocco fan 8 rotates, the ring gear 31 and the rotary body 25 rotate in synchronization with each other.

Further, the upper end portion of the rotary shaft 22 is inserted and fixed into the sun gear 32, and the rotary shaft 22 is rotated by the rotation of the sun gear 32.

Furthermore, the planetary gear 33 engages the ring gear 31 and the sun gear 32, and as the ring gear 31 rotates, it rotates continuously while revolving around the sun gear 32. Therefore, when the ring gear 31 rotates, the planetary gear 33 rotates inside the ring gear 31 and rotatably moves by revolving. In this way, the sun gear 32 rotates about the axis.

The number of teeth and the diameter of the ring gear 31, the planetary gear 33 and the sun gear 32 are set in a manner such that when the ring gear 31 makes one rotation by the sirocco fan 8, the sun gear 32 makes ten rotations. Therefore, in such a planetary gear mechanism 30, the rotational speed of sirocco fan 8 is increased 10 times to rotate sun gear 32, and this rotation causes the rotary shaft 22 to rotate at a speed which is 10 times that of sirocco fan 8.

The rotary shaft 22 projects downwardly from the upper casing 20, and the lower end of the rotary shaft 22 is located in the lower casing 21. Further, coil 35 is fixed to the inner peripheral surface of the lower casing (first fixed member) 21. On the other hand, a permanent magnet 36 is fixed to the lower end of the rotary shaft 22 with a predetermined gap formed between the magnet and the coil 35.

In this way, by virtue of the cooperation between the coil 35 and the permanent magnet 36, electricity can be generated and stored in the battery or can be directly used.

On the other hand, the permanent magnet 36 may be fixed to the lower casing 21 and the coil 35 maybe fixed to the rotary shaft 22.

Moreover, although not illustrated, on the outer peripheral surface of the permanent magnet 35, a plurality of inclined grooves inclining with respect to the rotary shaft 22 are formed in parallel at predetermined intervals in the circumferential direction. Then, when the permanent magnet 35 is rotated by virtue of the rotary shaft 22, air is sucked from the space below the permanent magnet 35 through the inclined grooves and blown out to the inside of the lower casing 21 to cool the inside portion. That is, the permanent magnet 35 has a cooling function in addition to the power generation function.

Further, as described above, the upper casing (second fixed member) 20 is provided inside the rotary body 25, and the cylindrical coil 37 is fixed to the outer peripheral surface of the upper casing 20. On the other hand, a permanent magnet 38 is fixed to the inner peripheral surface of the rotary body 25, with a predetermined interval formed between the magnet 38 and the coil 37.

Then, by virtue of the cooperation of between the coil 37 and the permanent magnet 38, electricity is generated and stored in the battery or used directly.

On the other hand, it is also possible to fix the permanent magnet 38 in the upper casing 20, and to fix the coil 37 onto the rotary body 25.

The wind power generator 1 provided with such a wind power rotating apparatus 2 is installed, for example, on a roof of a building, a roof of a house, or the like. Then, when the wind blows from a certain direction, the upper plate 6 rotates so that the inlet port 3a of the wind collection unit 3 faces the wind blowing direction, in a manner such that the wind strikes the side surface of the tail member 11 and this side surface and the wind blowing direction become parallel to each other.

At this time, the slider 13 provided in the wind collection unit 3 slides along the guide rail 12 provided on the installation surface on which the wind power generator 1 is installed, while the free wheels 14, 14 provided in the wind collection unit 3 travel along the circumferential direction of the guide rail 12 on the installation surface. In this way, the wind collection unit 3 rotates smoothly so that the wind inlet port 3a can turn to face the wind blowing direction.

Then, as shown in FIG. 7, when the wind is introduced through the inlet port 3a, since the wind collection unit 3 has a flow passage cross-section which is relatively large at the inlet port 3a and becomes narrower toward the outlet port 3b, the introduced wind (air) will be discharged from the outlet port 3b after being increased in flow velocity as a high-density high-pressure air.

In this way, the air discharged from the outlet port 3b is guided by the wind guide member 15 and hits some blades 8a of the sirocco fan 8 one after another, thus causing the sirocco fan 8 to rotate.

The rotation of the sirocco fan 8 causes the ring gear 31 of the planetary gear mechanism 30 to rotate, and the rotary body 25 rotates with the ring gear 31.

Further, part of the wind blowing over the outside of the inlet port 3a hits the cover member 19, and is reflected obliquely by the cover member 19, so that this wind will flow in a direction away from the sirocco fan 8. In this way, since the cover member 19 is provided, the wind does not hit the blades 8a located on the opposing outer peripheral surface of the sirocco fan 8. Therefore, the sirocco fan 8 can be smoothly rotated by the wind discharged from the outlet port 3b of the wind collection unit 3.

Since the permanent magnet 38 is fixed to the rotary body 25, the permanent magnet 38 rotates together with the rotary body 25. On the other hand, since the coil 37 is fixed to the upper casing 20 provided inside the rotary body 25, the electricity can be generated by the cooperation between the coil 37 and the permanent magnet 38, while the electricity thus generated can be stored in the battery, or can be put into direct use.

Further, when the ring gear 31 of the planetary gear mechanism 30 is rotated by the rotation of the sirocco fan 8, the sun gear 32 is also rotated via the planetary gear 33. Thus, when the sun gear 32 rotates, the rotary shaft 22 will also rotate together with the sun gear 32. The rotation speed of the rotary shaft 22 will be increased by the planetary gear mechanism 30 to reach a speed which is 10 times the rotation speed of the ring gear 31, i. e., the rotation speed of the sirocco fan 8.

Since the permanent magnet 36 is fixed to the lower end portion of the rotary shaft 22, the permanent magnet 26 rotates together with the rotary shaft 22. On the other hand, since the coil 35 is fixed to the lower casing 21 provided on the outside of the rotary shaft 22, the electricity can be generated by the cooperation between the coil 35 and the permanent magnet 36. The electricity thus generated is stored in the battery or can be put into use directly.

Here, since the coil 35 has a rotation speed which is ten times the coil 37, the electric power generated by the cooperation between the coil 35 and the permanent magnet 36 is larger than the electric power generated by the cooperation between the coil 37 and the permanent magnet 36.

As described above, according to the present embodiment, the wind power generator of the present invention includes: a wind collection unit 3 for introducing wind through the inlet port 3a, collecting the wind, and discharging the wind from the outlet 3b; a sirocco fan 8 rotated by wind (air) discharged from the outlet 3b of the wind collection unit 3; the rotation transmission mechanism (planet gear mechanism) 30 for transmitting the rotation of the sirocco fan 8 to the rotary shaft 22 while increasing its rotation speed.

Therefore, by virtue of the air discharged from the outlet port 3b of the wind collection unit 3, the rotation speed of the sirocco fan 8 is increased by the rotation transmission mechanism (planet gear mechanism) 30 and transmitted to the rotary shaft 22.

Therefore, even if the rotation speed of the sirocco fan 8 is low in the case of a slight wind or the like, the rotation speed of the rotary shaft 22 can be increased, so that the power generation can be effectively performed by connecting a power generator (permanent magnet 36 and coil 35) to the rotary shaft 22.

Further, since the ring gear 31 of the planetary gear mechanism 30 is attached to the sirocco fan 8, the sun gear 32 is attached to the rotary shaft 22, and the planetary gear 33 engages the ring gear 31 and the sun gear 32, it is possible to easily adjust the speed-up amount of the rotary shaft 22 by adjusting the number of teeth and the diameters of the gear 33 and the sun gear 32.

Moreover, since the sirocco fan 8 is rotated by the air discharged from the outlet port 3b of the wind collection unit 3 and the ring gear 31 is rotated by the rotation of the sirocco fan 8, it is possible to exactly transmit the rotation of the sirocco fan 8 to the rotary shaft 22 via the planetary gear 33 and the sun gear 32.

Moreover, since the wind collection unit 3 is formed such that its flow cross-section is relatively larger at the inlet port 3a and then becomes narrower towards the outlet port 3b, it is possible to discharge the introduced wind through the outlet port 3b with an increased wind speed. Therefore, the rotation speed of the sirocco fan 8 can be increased, so that the power generation efficiency can be improved.

Further, since the wind guide member 15 is provided between the outlet port 3b of the wind collection unit 3 and some of the blades 8a of the sirocco fan 8, the wind (air) discharged from the outlet port 3b can hit these blades 8a by virtue of the wind guide member 15. Therefore, it is possible to rotate the sirocco fan 8 smoothly.

In addition, since the rotary shaft 22 protrudes axially downward from the sirocco fan 8, the lower casing 21 is provided as a first fixed member on the outside of the protruding rotary shaft 22, the coil 35 is provided on the lower casing 21, the permanent magnet 36 is provided at the lower end portion of the rotary shaft 22, and since the rotation of the sirocco fan 8 can be accelerated by the planetary gear mechanism 30 and transmitted to the rotary shaft 2, it is possible that an efficient power generation can be achieved by the cooperation between the permanent magnet 36 and the coil 35, even if there is only a slight wind and the rotation speed of the sirocco fan 8 is low.

Furthermore, since the rotary body 25 is provided in the sirocco fan 8 via the ring gear 31, the permanent magnet 38 is provided in the rotary body 25, and the coil 37 is provided in the upper casing 20 serving as the second fixed member, it is possible to ensure an efficient power generation by the cooperation between the permanent magnet 38 and the coil 37.

That is, since electric power can be generated through the cooperation between the permanent magnet 36 and the coil 35 based on the rotation of the rotary shaft 22, also since electric power can be generated by the cooperation between the permanent magnet and the coil based on the rotation of the rotary body 25, it is possible to perform the power generation through two systems.

In the present embodiment, the planetary gear mechanism 30 is adopted as a rotation transmission mechanism for transmitting the rotation of the sirocco fan 8 to the rotary shaft 22 by increasing its rotational speed. On the other hand, it is also possible to use other rotation transmission mechanism which is not the planetary gear mechanism 30, as long as it is possible to transmit the rotation of sirocco fan 8 while increasing its rotation speed.

### EXPLANATIONS OF REFERENCE NUMERALS

1 wind power generator
2 wind rotating apparatus
3 wind collection unit
3a inlet port
3b outlet port
4 rotary member
8 sirocco fan
8a blades
15 wind guide member
20 upper casing (second fixed member)
21 lower casing (first fixed member)
22 rotary shaft
25 rotary body
30 planetary gear mechanism (rotation transmission mechanism)
31 ring gear
32 sun gear
33 planetary gear
35, 37 coils
36, 38 permanent magnets

1. A wind rotating apparatus, comprising:
a wind collection unit for introducing wind through an inlet port, collecting the wind and discharging the wind through an outlet port;
a rotary member which rotates about an axis by virtue of an air discharged from the outlet port of the wind collection unit;
a rotary shaft provided coaxially with the rotary member and rotatable about the axis; and
a rotation transmission mechanism for transmitting the rotation of the rotary member to the rotary shaft while increasing its rotation speed.

2. The wind rotating apparatus according to claim 1, wherein
the rotation transmission mechanism is constituted by a planetary gear mechanism,
a ring gear of the planetary gear mechanism is attached to the rotary member;
a sun gear of the planetary gear mechanism is attached to the rotary shaft;
a planetary gear of the planetary gear mechanism engages the ring gear and the sun gear.

3. The wind rotating apparatus according to claim 2, wherein the rotary member is constituted by a sirocco fan, and the ring gear is attached to the sirocco fan.

4. The wind rotating apparatus according to claim 3, wherein
the wind collection unit has a flow passage cross section which becomes smaller from the inlet-port towards the outlet port,
wind guider member for directing the air discharged from the outlet port to some of the blades is provided between the outlet port and some of the blades provided along the circumferential direction on the outer circumference of the sirocco fan.

5. A wind power generator provided with the wind rotating apparatus according to claim 1, wherein
the rotary shaft projects in the axial direction from the rotary member;
a first fixed member is provided on the outside of the protruding rotary shaft;
a permanent magnet is provided on one of the rotary shaft and the first fixed member, and a coil is provided on the other of the rotary shaft and the first fixed member, with a predetermined gap formed between the permanent magnet and the coil.

6. A wind power generator according to claim 5, wherein
a second fixed member is provided inside the rotary member of the wind rotating apparatus,
a permanent magnet is provided on one of the rotary member and the second fixed member, and a coil is provided on the other of the rotary member and the second fixed member, with a predetermined gap formed between the permanent magnet and the coil.
